(19) United States
(12) Patent Application Publication
(10) Pub. No.: US 2012/0234396 A1
(43) Pub. Date: Sep. 20, 2012

(54) PRESSURE REGULATOR WITH IMPROVED DEADBAND

(75) Inventor: Thomas M. Bell, Houston, TX (US)

(73) Assignee: Cameron International Corporation, Houston, TX (US)

(21) Appl. No.: 13/050,752

(22) Filed: Mar. 17, 2011

(51) Int. Cl. F16K 31/12

(52) U.S. Cl. 137/14; 137/492.5

(57) ABSTRACT

A pressure regulator is provided. In one embodiment, the pressure regulator includes a piston and supply seal rings, wherein the diameter of the piston is at least half of the sum of the diameters of the supply seal rings to reduce deadband and increase sensitivity. In another embodiment, the pressure regulator has a maximum deadband of less than 200 pounds per square inch when coupled to a supply pressure of at least 1000 pounds per square inch. Other embodiments related to pressure regulators are also provided.

### FIELD OF THE INVENTION

The present invention relates generally to pressure regulation within a system. More particularly, the present invention relates to a novel pressure-regulating device for such systems that exhibits improved sensitivity and deadband performance.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

As will be appreciated, supplies of oil and natural gas have a significant effect on modern economies and civilizations. Devices and systems that depend on oil and natural gas are ubiquitous. For instance, oil and natural gas are used for fuel in a wide variety of vehicles. Further, oil and natural gas are frequently used to heat homes during winter, to generate electricity, and to manufacture a wide array of everyday products.

In order to meet the demand for these resources, companies often spend a significant amount of time and money searching for and extracting oil, natural gas, and other subterranean resources from the earth. Particularly, once desired resources are discovered below the surface of the earth, drilling systems are often employed to access and extract the resource. These drilling systems may be located onshore or offshore depending on the location of a desired resource. Further, such systems include a wide array of components, such as valves, that control drilling or extraction operations. Often, some of these components are controlled through pressure variation, such as that provided by a hydraulic control system.

In some such systems, a hydraulic pressure regulator is used to provide a fluid at a regulated pressure to downstream components, such as solenoid valves. One common type of hydraulic pressure regulator has a control piston that moves back and forth to open and close both supply ports and vent ports of the regulator in response to the magnitude of pressure within the regulator. As the functionality of an entire drilling system may depend on proper operation of the hydraulic pressure regulator, it is generally desirable to employ a pressure regulator that is both durable and sensitive to changes in pressure. Further, when such a regulator is employed in a subsea application, halting production from the system to replace an underwater pressure regulator may be particularly undesirable. Additionally, many pressure regulators have excessive deadband that negatively impacts their ability to consistently provide an output pressure within a desired range, which may make such pressure regulators ill-suited for certain applications.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present invention generally relate to a novel pressure regulator exhibiting reduced deadband and improved sensitivity. In certain embodiments, the pressure regulator is a spring-loaded hydraulic pressure regulator configured for use in controlling components of a drilling system. In one embodiment, the pressure regulator includes a sensing piston and supply seal rings that operate to regulate flow of a control medium into the pressure regulator, and the ratio of the diameter of the piston to the sum of the diameters of the supply seal rings is greater than 0.50. The pressure regulator may also include one or more seal plates having an aperture that is partially shaped in accordance with the geometry of a respective portion of a mating seal ring to further improve sensitivity of the pressure regulator. Additional embodiments may also include various combinations of the features noted above.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of the some embodiments without limitation to the claimed subject matter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a resource extraction system having a pressure regulator in accordance with one embodiment;

FIG. 2 is a perspective view of a pressure regulator in accordance with one embodiment;

FIG. 3 is a cross-sectional view of the pressure regulator of FIG. 2, illustrating internal components of the pressure regulator in accordance with one embodiment;

FIG. 4 is a detailed sectional view of a portion of the pressure regulator of FIG. 3, depicting a position of an internal piston in which supply ports of the pressure regulator are open and vent ports of the pressure regulator are closed in accordance with one embodiment;

FIG. 5 is another sectional view of the pressure regulator of FIG. 3, generally depicting movement of the internal piston from the position of FIG. 4 to a position in which both the supply ports and the vent ports are closed in accordance with one embodiment;

FIG. 6 is an additional sectional view of the pressure regulator of FIG. 3, generally depicting movement of the internal piston from the position of FIG. 5 to a position in which the supply ports are closed and the vent ports are open in accordance with one embodiment;

FIG. 7 is a further detailed sectional view of the pressure regulator of FIG. 3 depicting relative dimensions of the internal piston and supply seal rings to lower deadband of the pressure regulator in accordance with one embodiment;

FIG. 8 is a perspective view of a seal plate of the pressure regulator of FIG. 3 in accordance with one embodiment; and

FIG. 9 is a sectional view of the seal plate of FIG. 8.

### DETAILED DESCRIPTION OF SPECIFIC EMBODIMENTS

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Moreover, any use of “top,” “bottom,” “above,” “below,” other directional terms, and variations of these terms is made for convenience, but does not require any particular orientation of the components.

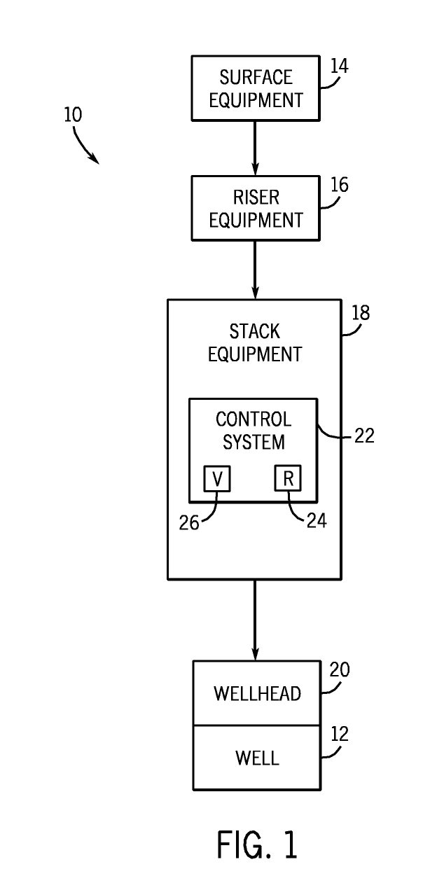

Turning now to the present figures, a drilling system 10 is illustrated in FIG. 1 in accordance with one embodiment. Notably, the system 10 facilitates extraction of a resource, such as oil or natural gas, from a well 12. The system 10 includes a variety of equipment, including surface equipment 14, riser equipment 16, and stack equipment 18, for extracting the resource from the well 12 via a wellhead 20. The system 10 may be employed in a variety of drilling or extraction applications, including onshore and offshore (i.e., subsea) drilling applications. In one subsea resource extraction application, the surface equipment 14 is mounted to a drilling rig above the surface of the water, the stack equipment 18 is coupled to the wellhead 20 near the sea floor, and the various equipment 14 and 18 is coupled to one another via the riser equipment 16.

As will be appreciated, the surface equipment 14 may include a variety of devices and systems, such as pumps, power supplies, cable and hose reels, control units, a diverter, a gimbal, a spider, and the like. Similarly, the riser equipment 16 may also include a variety of components, such as riser joints, fill valves, control units, and a pressure-temperature transducer, to name but a few. The riser equipment 16 facilitates transmission of the extracted resource to the surface equipment 14 from the stack equipment 18 and the well 12.

The stack equipment 18 may also include a number of components, such as blowout preventers, production trees (also known as “Christmas” trees), and the like for extracting the desired resource from the wellhead 20 and transmitting it to the surface equipment 14 and the riser equipment 16. In the presently illustrated embodiment, operation of the stack equipment 18 is controlled by a control system 22. The control system 22 includes a pressure regulator 24 and a plurality of valves 26 that control flow through the system 10. The pressure regulator 24 may include a configuration that exhibits reduced deadband and improved sensitivity, as described in further detail below. Additionally, in some embodiments, one or more of the plurality of valves include a blowout preventer, compose a portion of a Christmas tree, or both.

Further, in one embodiment, the pressure regulator 24 is a hydraulic pressure regulator and the plurality of valves 26 includes solenoid valves. As will be appreciated, valves 26 may be configured with a specific pressure rating, such as 3000 psi. An initial supply pressure may be provided to the pressure regulator 24 from a source of pressurized fluid, such as from a bank of accumulator tanks of the control system 22, that is higher than the pressure rating of various other system components, such as valves 26, to facilitate maintenance of adequate pressure to the other system components even during periods of high usage. For example, in some embodiments, the supply pressure may be 3000 psi or 5000 psi. But in other embodiments, other supply pressures may be provided, such as a supply pressure of at least 1000 psi. Indeed, any desired supply pressure may be used in accordance with the presently disclosed techniques. In the system 10, the pressure regulator 24 enables management of the supply pressure to deliver a regulated pressure to downstream components, such as the valves 26. While the pressure regulator 24 of the presently illustrated embodiment is a component of the stack equipment 18, it will be appreciated that, in other embodiments, the pressure regulator 24 may be disposed in other portions of the system 10, such as a component of the surface equipment 14, in full accordance with the present techniques. Additionally, certain embodiments may include multiple pressure regulators 24, which may be configured to receive and transmit control fluid at the same respective pressure levels as each other or, alternatively, such that two pressure regulators 24 each receive or transmit fluids at pressure levels that are different between the two regulators 24.

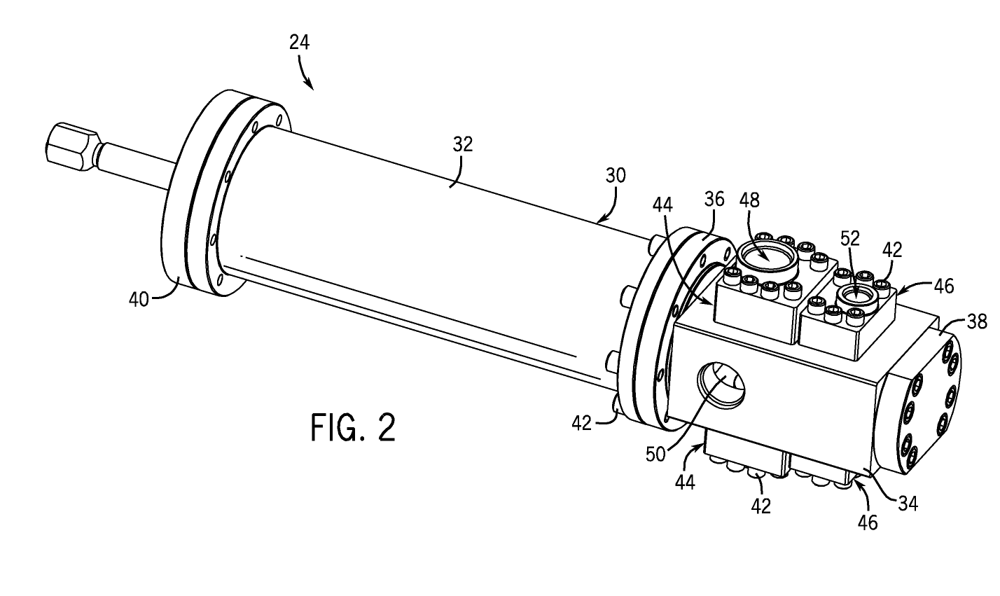

An example of a pressure regulator 24 is illustrated in FIG. 2 in accordance with one embodiment. The pressure regulator 24 includes an elongated housing or body 30 having an upper housing 32 and a lower housing 34 for receiving various internal components, as discussed in greater detail below. Upper and lower end caps 36 and 38 are secured to (e.g., fastened to or integrated with) the lower housing 34, and an end cap 40 is secured to the upper housing 32, to enclose the aforementioned internal components within the body 30. In one embodiment, one or both of the end caps 36 and 38 is secured to the lower housing 34 via a plurality of fasteners 42. While fasteners 42 may be provided in the form of bolts, such fastening may be provided in any suitable manner, such as via other mechanical fasteners or through other techniques (e.g., welding).

The pressure regulator 24 also includes a pair of supply assemblies 44 disposed on opposite sides of the lower housing 34, and a pair of vent assemblies 46, which are also disposed on opposite sides of the lower housing 34 from one another. The supply and vent assemblies 44 and 46 may be secured to the lower housing 34 in any suitable fashion, such as by fasteners 42. While the presently depicted pressure regulator 24 includes a pair of both supply pressure assemblies 44 and vent pressure assemblies 46, it should be noted that a different number of such assemblies could instead be employed in full accordance with the present techniques.

During operation, a control medium at a first (supply) pressure, such as 5000 psi, may enter the pressure regulator 24 through the supply ports 48 of the supply assemblies 44, and the control medium may be output at a second, regulated pressure, such as 3000 psi, via a regulated pressure outlet port 50 disposed in a side of the lower housing 34. Additionally, if the pressure inside the regulator 24 exceeds a certain threshold, the control medium may be vented from the regulator 24 through the vent ports 52 of the vent assemblies 46.

In the presently illustrated embodiment, the pressure regulator 24 is a hydraulic pressure regulator and the control medium includes hydraulic fluid. In other embodiments, however, the control medium may be some other material, such as a pressurized gas. Consequently, while the instant description of the illustrated embodiments may refer to a control fluid, it will be appreciated that such description may apply to a control liquid in a hydraulic pressure regulator in accordance with one embodiment, and does not necessarily preclude the use of a gaseous control medium in an alternative embodiment.

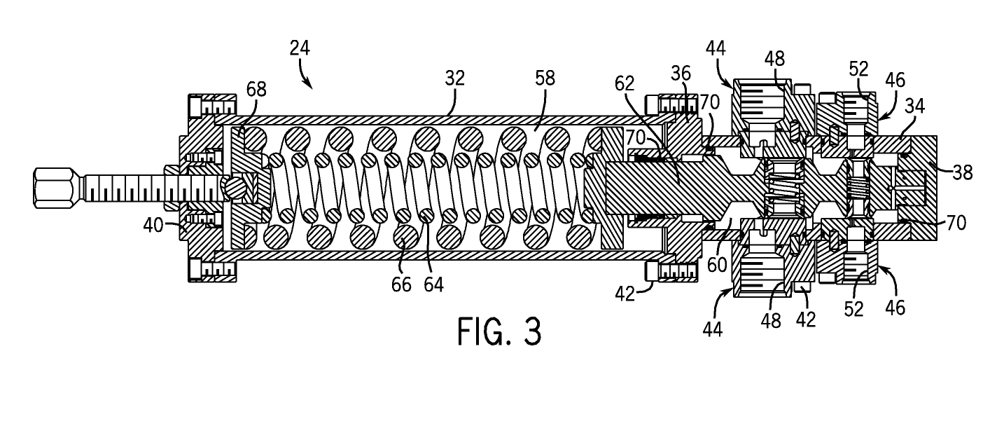

The internal operation of the regulator 24 may be better understood with reference to FIG. 3, which is a sectional view of the regulator 24 illustrated in FIG. 2. Notably, as illustrated in FIG. 3, the lower housing 34 generally defines an internal chamber 60 that receives control fluid from a source. A sensing piston 62 is disposed within the chamber 60 and extends through the upper end cap 36, which generally divides the chamber 60 from another chamber 58 in the upper housing 32. In the presently illustrated embodiment, the pressure regulator is spring-loaded in that a piston 62 is biased by one or more springs disposed in chamber 58, such as springs 64 and 66.

As discussed in greater detail below, pressure within the chamber 60 may apply a thrust force to the piston 62 that acts against the biasing force provided by springs 64 and 66 to control opening and closing of the supply ports 48 and vent ports 52. The biasing force supplied by springs 64 and 66 can be modified via a spring load adjustment mechanism 68 disposed at one end of the upper housing 32. The adjustment mechanism 68 includes a screw that may be rotated to cause axial movement of a plunger within the upper housing 32 to vary the biasing force, as illustrated in FIG. 3. As may be appreciated, the regulator 24 may also include various seals or o-rings 70, disposed between the components to maintain pressure within the regulator 24 and reduce or prevent leakage.

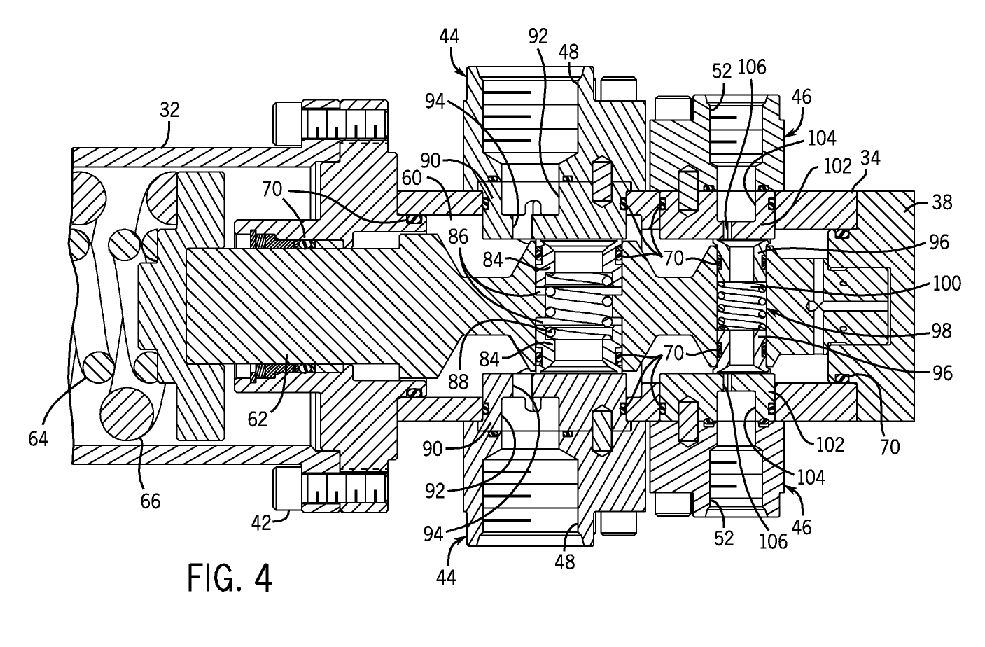

The opening and closing of the supply ports 48 and vent ports 52 may be better understood with reference to the sectional views of FIGS. 4-6. In the presently illustrated embodiment, the flow of control fluid or medium into the regulator 24 through the supply ports 48 is generally controlled by motion of the piston 62. More particularly, in one embodiment, supply shear seal rings 84 are disposed within one or more recesses 86 of the piston 62. A spring 88 may also be disposed within the one or more recesses 86 to bias the supply shear seal rings 84 against supply seal plates 90 of the supply assembly 44. In one embodiment, the supply seal plates 90 include a first fluid passageway 92 and a second fluid passageway 94 that facilitate flow of a control fluid through supply ports 48 to the chamber 60.

Similarly, in the present embodiment, vent shear seal rings 96 are disposed within one or more recesses 98 of the piston 62. The vent shear seal rings 96 are biased by a spring 100 against a pair of vent seal plates 102. The vent seal plates 102 also include first and second fluid passageways 104 and 106, respectively, which enable fluid to be vented from the chamber 60 through the vent ports 52. In the presently illustrated embodiment, the vent seal rings 96 are of a different size than the supply seal rings 84. Further, the various passageways of the seal plates 90 and 102, respectively, may also be of different sizes than one another based on the particular sizes and geometries of the seal rings 84 and 96, as discussed in greater detail below.

An initial operating state is depicted in FIG. 4, in which the supply ports 48 are open and the vent ports 52 are closed with respect to the interior of the pressure regulator 24. This configuration allows the control medium to enter the pressure regulator 24 through the supply ports 48 and exit through the regulated pressure outlet port 50, as discussed above. As will be appreciated, hydraulic or pneumatic pressure within the chamber 60 generally results in a thrust force applied to the piston 62 against the biasing force applied by the springs 64 and 66. Further, various frictional forces, such as that resulting from contact of the shear seal rings 84 and seal plates 90, may also oppose movement of the piston 62 during operation. If the thrust generated by the pressure within the chamber 60 is below a first pressure threshold (which is generally dictated by the frictional and biasing forces noted above), the supply ports 48 remain open to allow additional control fluid to enter the pressure regulator 24 and exit through the outlet port 50. In one example, the first pressure threshold may be substantially equal to a desired operating pressure of downstream components, such as 300 psi, 400 psi, 500 psi, 1000 psi, 1500 psi, 2000 psi, 3000 psi, or 5000 psi to name but a few examples.

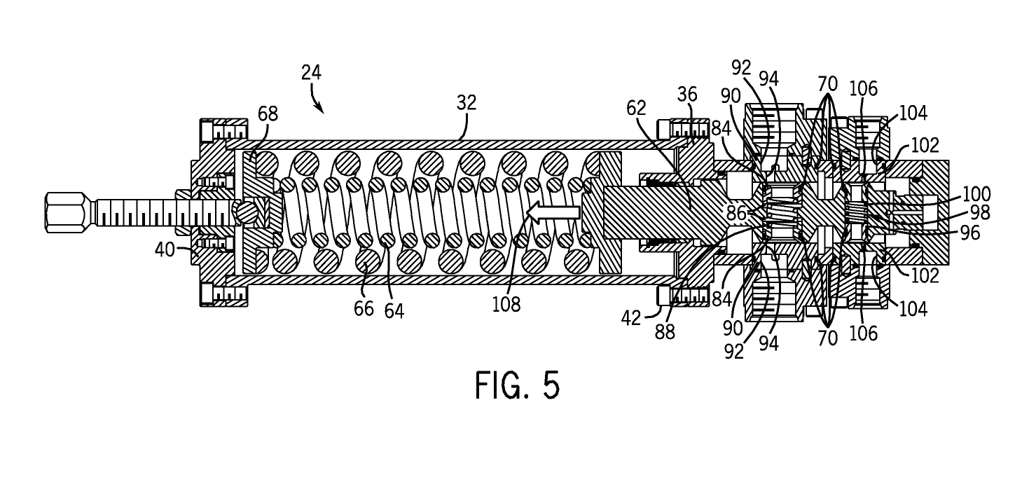

As the pressure downstream and within the regulator 24 increases and approaches the first pressure threshold, the hydraulic force on the piston 62 becomes sufficient to move the piston 62 in the direction indicated by arrow 108 and toward the closed position generally illustrated in FIG. 5. Particularly, in the presently illustrated embodiment, the springs 64 and 66, the supply seal rings 84, and the piston 62 are configured such that the supply seal rings 84 are moved into a fully closed position, in which the supply seal rings 84 are disposed over the entirety of the second fluid passageway 94, when the pressure within the chamber 60 reaches or exceeds the first pressure threshold. Upon reaching this threshold, the pressure regulator may be considered to be in a state of equilibrium, in which both the supply and vent ports 48 and 52 are closed and no control medium flows through the regulator 24. In other words, at this operational point, the pressure inside the chamber 60 is above the first pressure threshold, causing the piston 62 to move the supply seal rings 84 into a closed position, but is insufficient to cause the piston 62 to move the vent seal rings 96 enough to open the vent ports 52.

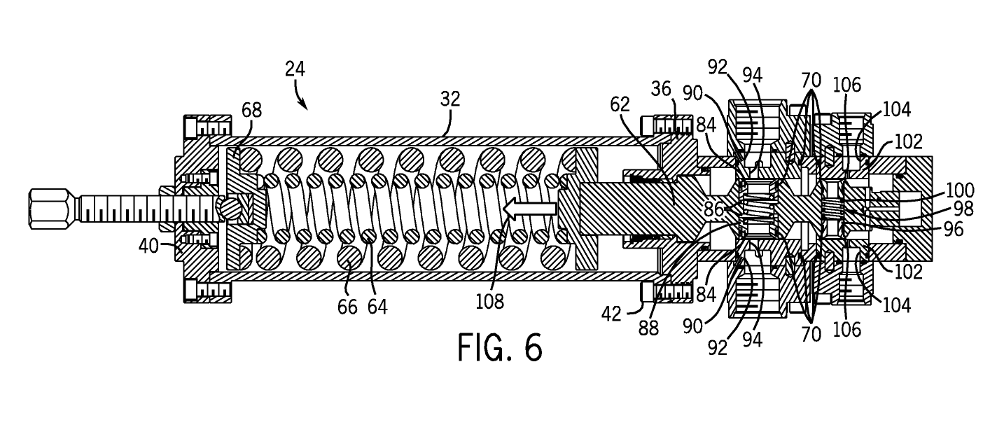

As may be appreciated, as the pressure within the pressure regulator 24 continues to increase beyond the first pressure threshold, the thrust applied to the piston 62 by the internal pressure also increases, causing the piston 62 to continue moving in the direction indicated by arrow 108. As the internal pressure reaches a second pressure threshold, the piston 62 and vent seal rings 96 are moved into an open position, as generally illustrated in FIG. 6, allowing control fluid within the chamber 62 to be vented out of the pressure regulator 24 via vent ports 52. Additionally, it is noted that in some embodiments the pressure regulator 24 may have separate, independent pistons for the supply seal rings 84 and the vent seal rings 96, such as described in U.S. Pat. No. 7,520,297, issued on Apr. 21, 2009, and entitled “Pressure Regulator Device and System,” which is herein incorporated by reference in its entirety.

As previously noted, excessive deadband in a pressure regulator may negatively impact its ability to provide a reasonably steady desired output pressure. For example, a pressure regulator having a deadband of 400 psi would not operate effectively to provide a hydraulic fluid at a regulated output pressure of 300 psi—in such an instance the output pressure could drop to zero without the pressure regulator even responding due to its deadband limitations. In the field of resource exploration and procurement, there has long been a need in the art for a spring-loaded, hydraulic pressure regulator with the degree of sensitivity that would enable the regulator to effectively operate at lower pressure levels. For instance, there are occasions in which pressure to an annular blowout preventer is to be maintained at a level as low as 300 psi to 400 psi. The presently disclosed pressure regulator meets this long-felt need and exhibits increased sensitivity and decreased deadband. In some embodiments, the pressure regulator 24 has a maximum deadband of 200 psi or less when coupled to a source of pressurized fluid providing a supply pressure of at least 1000 psi. In other embodiments, the maximum deadband may instead be 180 psi or less, 160 psi or less, 150 psi or less, 130 psi or less, 120 psi or less, or some other amount. Indeed, in testing with a supply pressure of 3000 psi, one example of the presently disclosed pressure regulator demonstrated a maximum deadband significantly lower than 150 psi, the level specified in the American Petroleum Institute Specification 16D published Jul. 1, 2004, which is incorporated by reference herein.

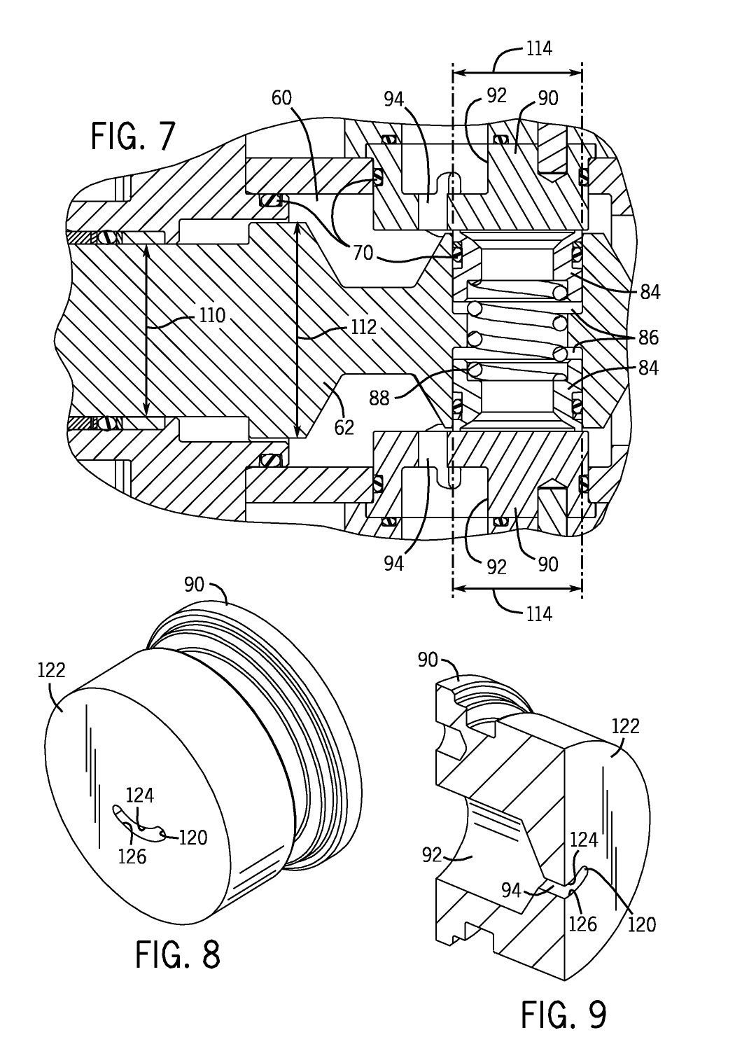

Various features contributing to the improved deadband characteristics of the presently disclosed pressure regulator are depicted in FIGS. 7-9 in accordance with one embodiment. Particularly, as shown in FIG. 7, the piston 62 includes a portion that passes through the end cap 36 and has a diameter (or width) 110 generally orthogonal to the axis of movement of the piston 62. The piston 62 may also include an enlarged portion within the chamber 60 that has a diameter (or width) 112. Each supply seal ring 84 includes a diameter (or width) 114 generally parallel to the axis of movement of the piston 62. In various embodiments of the present technique, the sensitivity of the pressure regulator 24 is significantly improved by providing the piston 62 with a relatively large diameter 110 in comparison to the sum of the diameters 114 of the supply seal rings 84. For example, in one embodiment, the diameter 110 is one-and-a-half inches and the diameter of each supply seal ring 84 is one and one-eighth inches. This may also be expressed as a ratio of the diameter 110 to the sum of the diameters 114—a ratio of about 0.667 in the immediately preceding example. In contrast, previous pressure regulators may exhibit a much smaller ratio, such as 0.250. In other embodiments, the ratio of the diameter 110 to the sum of the diameters 114 may have a different value, such as at least 0.40, at least 0.50, at least 0.65, at least 0.75, at least 0.90, at least 1.00, or some other value. In the present embodiment, the larger diameter of the piston 62 relative to the supply seal rings 84 allows the piston 62 to develop hydraulic thrust sufficient to overcome frictional resistance of the supply seal rings 84 more quickly than previous regulators having a lower ratio of piston diameter to supply seal ring diameters.

Additionally, in at least some embodiments, the supply seal plates 90 may be specifically configured based on the geometries of their respective seal rings 84 to further improve the sensitivity of the pressure regulator 24. For instance, in the embodiment illustrated in FIGS. 8 and 9, a supply seal plate 90 includes an arcuate opening or aperture 120 defined by the exit of the second passageway 94 at a surface 122 of the supply seal plate 90, rather than a circular or elliptical opening. As will be appreciated, a shear supply seal ring 84 (FIG. 4) may operate to selectively cover and uncover the arcuate opening 120 to control flow through the fluid passageways 92 and 94, as discussed above. Notably, in one embodiment the arcuate opening 120 includes curved inner and outer edges 124 and 126, respectively, that are each concave in the same direction (as opposed to an elliptical opening in which opposing sides have opposing concavities). Such apertures 120 may also be referred to as “kidney bean” or bow-shaped apertures. In certain embodiments, the shape of the aperture 120 is related to the shape of a respective seal ring 84. For instance, in one embodiment, the curved outer edge 126 of the aperture 120 has a rate of curvature that is substantially identical (e.g., within manufacturing tolerances) to that of an inner circumference or perimeter of a lip of the seal ring 84 such that a portion of the inner edge or perimeter of the seal ring 84 is substantially coincident with the curved outer edge 126 when pressure within the pressure regulator 24 is substantially equal to the first pressure threshold. In some embodiments, the curved inner edge 124 may have a rate of curvature that is substantially identical to the outer circumference of the seal ring 84. Other configurations in which the curved inner and outer edges 124 or 126 are configured based on other surfaces of the seal ring 84 are also envisaged.

Similarly, vent seal plates 102 (FIG. 4) may also include an arcuate aperture that includes an edge coincident to an edge of a vent seal ring 96 when pressure within the regulator 24 is substantially equal to the second pressure threshold. While the seal plates 90 and 102 may be substantially identical to one another in some embodiments, the apertures of the seal plates 90 and 102 may instead have different sizes or geometries than one another to provide different flow rates through their respective passages and to match differences in the geometries of seal rings 84 and 96. The shaping of the apertures in the supply seal plates 90, the vent seal plates 102, or both reduces the movement of the piston 62 in opening and closing the fluid passageways of these seal plates, further increasing the sensitivity and decreasing the deadband of the pressure regulator 24.

In one embodiment, the pressure regulator 24 is a one-inch, spring-loaded, manually adjustable hydraulic pressure regulator. Test results of such a pressure regulator 24 are provided below in Tables 1 and Table 2. Table 1 provides data obtained for a supply pressure of 3000 psi to the regulator, and Table 2 provides data obtained for a supply pressure of 5000 psi to the regulator. Particularly, the tables provide data obtained in testing the pressure regulator over a range of spring loads (represented by the number of complete turns of the screw of adjustment mechanism 68).

TABLE 1

| | Regulated | | | | | | | | |
|---|---|---|---|---|---|---|---|---|---|
| Spring | Pressure | | | | | | | | |
| Load | (after | Test for Deadband | | | | Test for Vent Pressure | | | |
| (No. of | operating | Starting | Min. | Difference | Final | Starting | Max. | | Final |
| turns) | cylinder) | Pressure | Press. | (Deadband) | Pressure | Pressure | Press. | Difference | Pressure |
| 1 | 112 | 112 | N/A | N/A | 2 | 110 | 350 | 240 | 180 |
| 2 | 195 | 193 | 78 | 115 | 196 | 195 | 480 | 285 | 310 |
| 3 | 310 | 310 | 200 | 110 | 320 | 320 | 610 | 290 | 443 |
| 4 | 405 | 404 | 345 | 59 | 457 | 456 | 750 | 294 | 585 |
| 5 | 575 | 575 | 470 | 105 | 588 | 587 | 880 | 293 | 720 |
| 6 | 705 | 703 | 600 | 103 | 720 | 718 | 1020 | 297 | 856 |
| 7 | 845 | 843 | 740 | 103 | 855 | 853 | 1150 | 297 | 995 |
| 8 | 978 | 977 | 870 | 107 | 985 | 980 | 1285 | 305 | 1130 |
| 9 | 1112 | 1110 | 1030 | 80 | 1116 | 1115 | 1415 | 300 | 1265 |
| 10 | 1236 | 1200 | 1130 | 70 | 1255 | 1255 | 1545 | 290 | 1405 |
| 11 | 1380 | 1380 | 1270 | 110 | 1385 | 1384 | 1670 | 286 | 1535 |
| 12 | 1512 | 1510 | 1408 | 102 | 1518 | 1517 | 1800 | 283 | 1670 |
| 13 | 1630 | 1640 | 1535 | 105 | 1645 | 1648 | 1930 | 282 | 1835 |
| 14 | 1772 | 1772 | 1665 | 107 | 1775 | 1777 | 2055 | 278 | 1938 |
| 15 | 1900 | 1900 | 1798 | 102 | 1905 | 1906 | 2185 | 279 | 2100 |
| 16 | 2031 | 2031 | 1925 | 106 | 2035 | 2035 | 2320 | 285 | 2200 |
| 17 | 2160 | 2150 | 2058 | 92 | 2165 | 2165 | 2450 | 285 | 2330 |
| 18 | 2286 | 2286 | 2190 | 96 | 2291 | 2291 | 2580 | 289 | 2468 |
| 19 | 2411 | 2411 | 2315 | 96 | 2413 | 2413 | 2710 | 297 | 2605 |
| 20 | 2538 | 2537 | 2445 | 92 | 2541 | 2541 | 2840 | 299 | 2742 |
| 21 | 2670 | 2669 | 2585 | 84 | 2672 | 2672 | 2970 | 298 | 2876 |
| 22 | 2802 | 2802 | 2710 | 92 | 2802 | 2802 | 3105 | 303 | 3008 |
| 23 | 2934 | 2933 | 2845 | 88 | 2933 | 2933 | 3123 | N/A | N/A |

TABLE 2

| | Regulated | | | | | | | | |
|---|---|---|---|---|---|---|---|---|---|
| Spring | Pressure | | | | | | | | |
| Load | (after | Test for Deadband | | | | Test for Vent Pressure | | | |
| (No. of | operating | Starting | Min. | Difference | Final | Starting | Max. | | Final |
| turns) | cylinder) | Pressure | Press. | (Deadband) | Pressure | Pressure | Press. | Difference | Pressure |
| 1 | 112 | 112 | N/A | N/A | N/A | 165 | 440 | 275 | 202 |
| 2 | 275 | 272 | 108 | 164 | 273 | 272 | 560 | 288 | 275 |
| 3 | 403 | 400 | 240 | 160 | 405 | 404 | 680 | 276 | 470 |
| 4 | 536 | 535 | 355 | 180 | 540 | 538 | 835 | 297 | 603 |
| 5 | 629 | 628 | 500 | 128 | 677 | 675 | 955 | 280 | 755 |
| 6 | 790 | 788 | 645 | 143 | 804 | 802 | 1110 | 308 | 890 |
| 7 | 920 | 917 | 780 | 137 | 940 | 940 | 1250 | 310 | 1028 |
| 8 | 1120 | 1115 | 935 | 180 | 1073 | 1072 | 1360 | 288 | 1165 |
| 9 | 1197 | 1195 | 1050 | 145 | 1205 | 1205 | 1500 | 295 | 1305 |
| 10 | 1316 | 1315 | 1180 | 135 | 1337 | 1335 | 1640 | 305 | 1436 |
| 11 | 1440 | 1437 | 1320 | 117 | 1473 | 1467 | 1780 | 313 | 1572 |
| 12 | 1583 | 1580 | 1480 | 100 | 1607 | 1605 | 1900 | 295 | 1705 |
| 13 | 1710 | 1706 | 1585 | 121 | 1730 | 1730 | 2045 | 315 | 1750 |
| 14 | 1846 | 1845 | 1735 | 110 | 1862 | 1860 | 2150 | 290 | 1965 |
| 15 | 1963 | 1962 | 1845 | 117 | 1987 | 1986 | 2290 | 304 | 2100 |
| 16 | 2082 | 2081 | 1970 | 111 | 2115 | 2120 | 2430 | 310 | 2231 |
| 17 | 2225 | 2221 | 2120 | 101 | 2224 | 2223 | 2550 | 327 | 2355 |
| 18 | 2350 | 2349 | 2230 | 119 | 2368 | 2368 | 2670 | 302 | 2490 |
| 19 | 2480 | 2480 | 2360 | 120 | 2488 | 2490 | 2820 | 330 | 2630 |
| 20 | 2610 | 2610 | 2490 | 120 | 2630 | 2630 | 2940 | 310 | 2770 |
| 21 | 2741 | 2740 | 2630 | 110 | 2735 | 2736 | 3020 | 284 | 2892 |
| 22 | 2870 | 2870 | 2765 | 105 | 2889 | 2887 | 3210 | 323 | 3045 |
| 23 | 2994 | 2992 | 2840 | 152 | 3015 | 3014 | 3315 | 301 | 3160 |
| 24 | 3085 | 3085 | 3000 | 85 | 3105 | 3110 | 3450 | 340 | 3295 |
| 25 | 3230 | 3230 | 3120 | 110 | 3250 | 3249 | 3575 | 326 | 3410 |
| 25.5 | 3285 | 3285 | 3170 | 115 | 3302 | 3302 | 3610 | 308 | 3570 |

It is noted that in both instances (supply pressures of 3000 psi and 5000 psi), the pressure regulator 24 has a maximum deadband of less than 200 psi. Further, at a supply pressure of 3000 psi, the maximum deadband of the pressure regulator 24 was less than 120 psi, and the average deadband was less than 100 psi. At a supply pressure of 5000 psi, the maximum deadband measured was no higher than 180 psi, and the average deadband of the pressure regulator 24 was less than 130 psi. Additionally, as indicated in the tables above, the screw of the adjustment mechanism 68 may be rotated through multiple revolutions. Due to the improved sensitivity and lower deadband, the response of the presently disclosed pressure regulator 24 may be substantially more linear than that of previous regulators in that the piston 62 may move, and the output pressure may change, during each revolution of the screw, as generally demonstrated by the tables above. This is in contrast with previous regulators that may require several revolutions of an adjustment screw before the piston responds.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

1. A system comprising:
a spring-loaded hydraulic pressure regulator having a maximum deadband of less than 200 pounds per square inch when coupled to a source of pressurized fluid having a supply pressure of at least 1000 pounds per square inch, the spring-loaded hydraulic pressure regulator including:
a housing having first and second inner chambers;
a spring disposed within the second chamber;
a sensing piston disposed within the housing and responsive to pressure within the first inner chamber and to a biasing force generated by the spring; and
a supply seal ring disposed within the first chamber.

2. The system of claim 1, wherein the maximum deadband of the spring-loaded hydraulic pressure regulator is less than 120 pounds per square inch for a supply pressure of 3000 pounds per square inch.

3. The system of claim 1, wherein the average deadband of the spring-loaded hydraulic pressure regulator is less than 100 pounds per square inch for a supply pressure of 3000 pounds per square inch.

4. The system of claim 1, wherein the average deadband of the spring-loaded hydraulic pressure regulator is less than 130 pounds per square inch for a supply pressure of 5000 pounds per square inch.

5. The system of claim 1, wherein an output pressure of the spring-loaded hydraulic pressure regulator is manually adjustable.

6. The system of claim 1, comprising an adjustment mechanism enabling manual adjustment of compression of the spring disposed within the second chamber.

7. The system of claim 1, comprising a blowout preventer and an associated control system that includes the spring-loaded hydraulic pressure regulator.

8. The system of claim 1, wherein the sensing piston includes only a single sensing piston.

9. The system of claim 1, comprising the source of pressurized fluid.

10. A device comprising:
a spring-loaded hydraulic pressure regulator including:
a housing having a first chamber for receiving a pressurized fluid and a second chamber separated from the first chamber by a dividing structure;
a piston disposed in the first chamber, the piston including a portion extending into the second chamber through an aperture in the dividing structure;
a spring disposed in the second chamber and positioned to bias the piston into the first chamber;
a plurality of supply seal rings disposed within the first chamber and configured to selectively allow the pressurized fluid to enter the first chamber;
wherein the ratio of a diameter of the portion of the piston extending through the aperture in the dividing structure to the sum of the diameters of the plurality of supply seal rings is greater than 0.50 to reduce deadband and increase sensitivity of the spring-loaded hydraulic pressure regulator.

11. The device of claim 10, wherein the ratio of the diameter of the portion of the piston extending through the aperture in the dividing structure to the sum of the diameters of the plurality of supply seal rings is greater than 0.65 to reduce deadband and increase sensitivity of the spring-loaded hydraulic pressure regulator.

12. The device of claim 10, comprising a plurality of supply seal plates with apertures to facilitate flow of the pressurized fluid into the first chamber.

13. The device of claim 12, wherein the apertures are arcuate apertures having opposing sides with the same direction of concavity.

14. The device of claim 12, wherein the spring-loaded hydraulic pressure regulator includes only two supply seal rings.

15. The device of claim 10, wherein each of the supply seal rings of the plurality of supply seal rings is disposed within the piston.

16. The device of claim 10, wherein the spring-loaded hydraulic pressure regulator includes a plurality of vent seal rings.

17. The device of claim 16, comprising a plurality of vent seal plates having apertures to facilitate venting of the pressurized fluid out of the first chamber if the pressure of the pressurized fluid exceeds a threshold level.

18. The device of claim 10, wherein the spring-loaded hydraulic pressure regulator includes a plurality of springs disposed in the second chamber positioned to bias the piston into the first chamber.

19. A method comprising:
receiving a fluid within a chamber of a pressure regulator, wherein the pressure regulator is a spring-loaded, hydraulic pressure regulator that includes a manual adjustment mechanism with a rotatable screw;
translating rotation of the screw into axial movement of a plunger of the manual adjustment mechanism to change a biasing force applied to a piston in the pressure regulator by a spring; and
moving the piston in response to rotation of the screw through multiple revolutions and to the resulting changes in the biasing force such that the piston moves and an output pressure of the pressure regulator changes during each revolution of the screw.

20. The method of claim 19, wherein receiving the fluid includes receiving the fluid pressurized to about 3000 pounds per square inch.

21. The method of claim 20, wherein receiving the fluid includes receiving the fluid pressurized to about 5000 pounds per square inch.
